(19) United States
(12) Patent Application Publication
(10) Pub. No.: US 2014/0189980 A1
(43) Pub. Date: Jul. 10, 2014

(54) Smart caster having function of preventing free rolling

(71) Applicants: SUNWOONG CHOI, Daejeon-si (KR); SOOHO PYO, Chungcheongbuk-do (KR); HYUNMIN BAE, Daejeon-si (KR)

(72) Inventor: Sooho PYO, Chungcheongbuk-do (KR)

(73) Assignees: Sunwoong CHOI, Daejeon-si (KR); Hyunmin BAE, Daejeon-si (KR); Sooho PYO, Chungcheongbuk-do (KR)

(21) Appl. No.: 13/737,980

(22) Filed: Jan. 10, 2013

(51) Int. Cl. B60B 33/00

(52) U.S. Cl. CPC B60B 33/0094; B60B 33/0086
USPC 16/35 R

(57) ABSTRACT

Disclosed therein is a smart caster having a function of preventing free rolling, which prevents a rotation irrelevant to a user's intention in a stopped state. The smart caster includes: a wheel part having a wheel rotatably joined to a wheel shaft and a bearing interposed between the wheel and the wheel shaft; and a braking part rotatably joined to the wheel shaft, the braking part getting in contact with a wheel inner wall in a stopped state to provide braking force to the wheel and releasing a contact state between the braking part and the wheel inner wall in a rolling state of the wheel to remove the braking force of the wheel.

### BACKGROUND OF THE INVENTION

1. Field of the Invention

The present invention relates to a smart caster having a function of preventing free rolling, and more particularly, to a smart caster having a function of preventing free rolling, which prevents a rotation irrelevant to a user's intention in a stopped state.

2. Background Art

In general, non-powered carrying equipment such as baby carriages, handcarts, and so on has small-sized lightweight wheels or casters in order to reduce a load during carrying.

Such non-powered carrying equipment having the small-sized wheels includes a brake device in order to prevent rotation of the wheels when a user wants to keep a stopped state because they do not have any brake system.

The brake devices are divided into brake devices which carry out a stopping action during driving by the user's handle manipulation and brake devices which are mounted on a caster to keep the stopped state.

As an example of the non-powered carrying equipment carrying out the brake function by the user's handle manipulation, Korean Utility Model Registration No. 20-210491 discloses a ‘Baby carriage having a brake device’.

The conventional baby carriage includes a brake string adjustable ring mounted on a brake string and mounted at the middle part between right and left brake handles and a brake handle string having one side connected to the brake string adjustable ring and the other side fixed to a brake operation shaft mounted on a brake handle, so that brake linings are simultaneously operated without regard to that the user grasps all of the right and left brake handles at the same time or grasps one of the brake handles.

Moreover, as an example of the conventional carrying equipment having the brake device which is mounted on the caster to carry out the brake function, Korean Patent Laid-open No. 2010-0072442 discloses a ‘Brake for casters’. In Korean Patent Laid-open No. 2010-0072442, the brake includes a rotation member and a lifting member of the same shape which are mounted vertically, wherein the rotation member lowers the lifting member and a press lever while rotating by a user's manipulation of an operation lever so as to apply pressure to a wheel, so that the wheel is pressed and fixed when the press lever lowers through a rotary force of the operation lever.

That is, in order to keep the stopped state of the conventional non-powered carrying equipment, the user has to manipulate the brake device mounted on the caster to make the stopped state whenever the carrying equipment is stopped.

Moreover, the conventional non-powered carrying equipment has another problem in that there may occur accidents if the user does not manipulate the brake device into the stopped state on an inclined plane.

Furthermore, the conventional non-powered carrying equipment has a further problem in that the brake device has a complicated structure to carry out the brake function.

### SUMMARY OF THE INVENTION

Accordingly, the present invention has been made to solve the above-mentioned problems occurring in the prior arts, and it is an object of the present invention to provide a smart caster having a function of preventing free rolling, which can automatically provide a braking force to wheels when a non-powered carriage equipment is stopped and automatically remove the braking force from the wheels when the non-powered carriage equipment moves.

To achieve the above objects, the present invention provides a smart caster having a function of preventing free rolling including: a wheel part having a wheel rotatably joined to a wheel shaft and a bearing interposed between the wheel and the wheel shaft; and a braking part rotatably joined to the wheel shaft, the braking part getting in contact with a wheel inner wall in a stopped state to provide braking force to the wheel and releasing a contact state between the braking part and the wheel inner wall in a rolling state of the wheel to remove the braking force of the wheel.

The braking part includes: a brake shoe having an end portion hinge-coupled to the wheel shaft and rotatably located between the wheel inner wall and the wheel shaft in such a fashion that the brake shoe gets in contact with a wheel inner wall in the stopped state to provide braking force to the wheel and releases a contact state between the braking part and the wheel inner wall in the rolling state of the wheel to remove the braking force of the wheel; and elastic bodies joined to the wheel shaft and the brake shoe, so that the brake shoe is located at right angles to an axial direction of the wheel shaft in the stopped state of the wheel.

The brake shoe further includes a brake protrusion protruding on the face getting in contact with the wheel inner wall in a direction of the wheel inner wall and getting in contact with the wheel inner wall so that the brake shoe is easily in contact with the wheel and the contact state between the wheel and the brake shoe is easily removed.

The brake protrusion includes a friction member in order to increase the friction force with the wheel inner wall.

The braking part further includes a support ring joined on the shaft of the wheel shaft and hinge-coupled to an end portion of the brake shoe opposed to the wheel shaft, the support ring being joined with the elastic bodies, which elastically support both sides of the brake shoe and the hinge-coupled sides of the support ring.

The support ring includes elastic body supporting portions protruding on both sides where the brake shoe is hinge-coupled.

A pair of the braking parts are joined to both sides of the wheel shaft of the wheel in such a fashion that the braking parts are respectively in contact with the wheel inner walls formed at both sides of the wheel.

The smart caster having the function of preventing free rolling according to the present invention provides the braking force by keeping a contact state between the braking protrusion of the brake shoe and the wheel inner wall of the wheel when the non-powered carriage equipment, such as baby walkers, carts, handcarts, and so on, stops movement. Therefore, the present invention can enhance stability in the stopped state of the non-powered carriage equipment because it prevents the user's undesirable rotation of the wheels during the stop of the non-powered carriage equipment. Such effect is increased more in an aspect that the smart caster according to the present invention prevents the undesirable rolling of the non-powered carriage equipment when the user manipulates the non-powered carriage equipment on an inclined plane.

Additionally, the smart caster according to the present invention automatically provides the braking force to the brake shoe when the non-powered carriage equipment stops. Accordingly, the smart caster according to the present invention remarkably enhances convenience in use because it is not necessary to manipulate additional brake locking device such as a caster brake when the user stops the non-powered carriage equipment, such as baby carriages, carts, handcarts, and so on, on the inclined plane.

In addition, the smart caster according to the present invention has the braking device for providing the braking force, which is simpler in structure than the conventional braking devices, so that the smart caster provides effects of reducing the number of components of the braking device and reducing manufacturing expenses.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view of the right side of a caster having a function of preventing a free rolling according to the present invention;

FIG. 2 is an exploded perspective view of the left side of the caster of FIG. 1;

FIG. 3 is an exploded perspective view of the right side of the caster of FIG. 1;

FIG. 4 is a view showing a braking action of a brake shoe in a stopped state of the caster of FIG. 1;

FIG. 5 is a view showing a brake releasing action when the caster of FIG. 1 rotates in the counterclockwise direction; and

FIG. 6 is a view showing a brake releasing action when the caster of FIG. 1 rotates in the clockwise direction.

### DETAILED DESCRIPTION OF THE PREFERRED EMBODIMENT

Reference will be now made in detail to the preferred embodiment of the present invention with reference to the attached drawings.

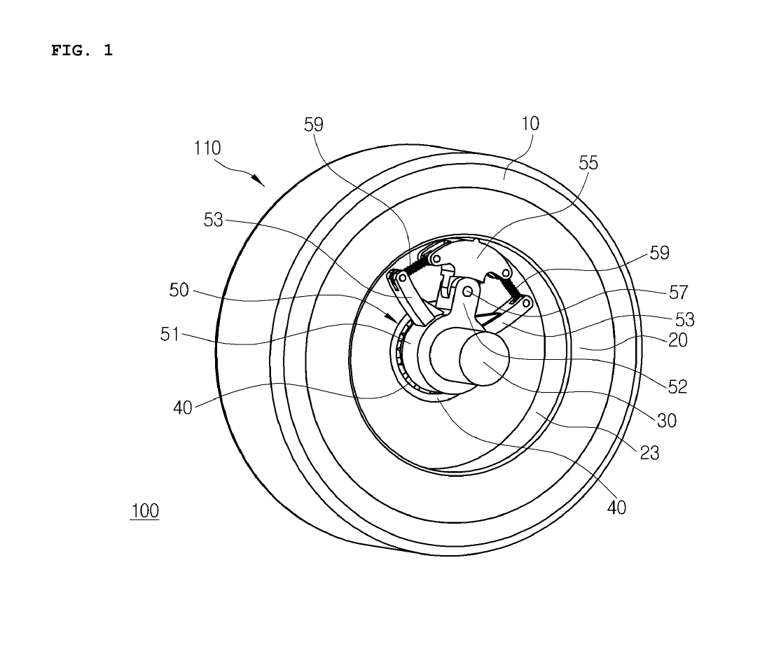

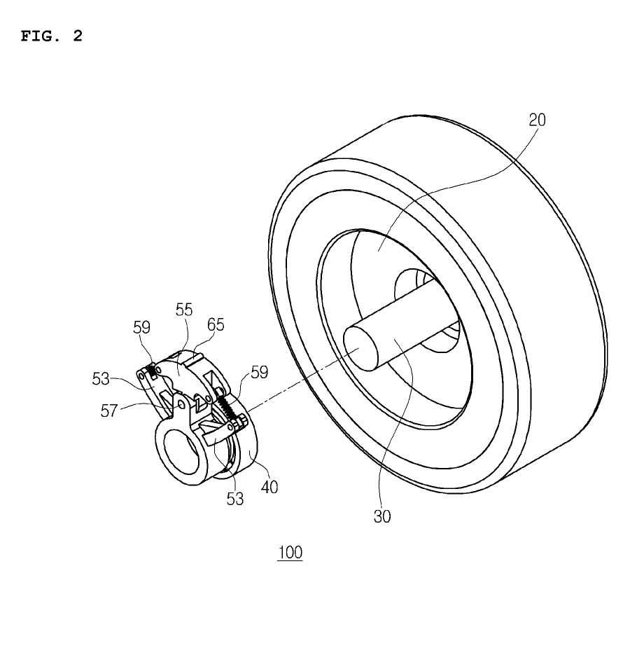

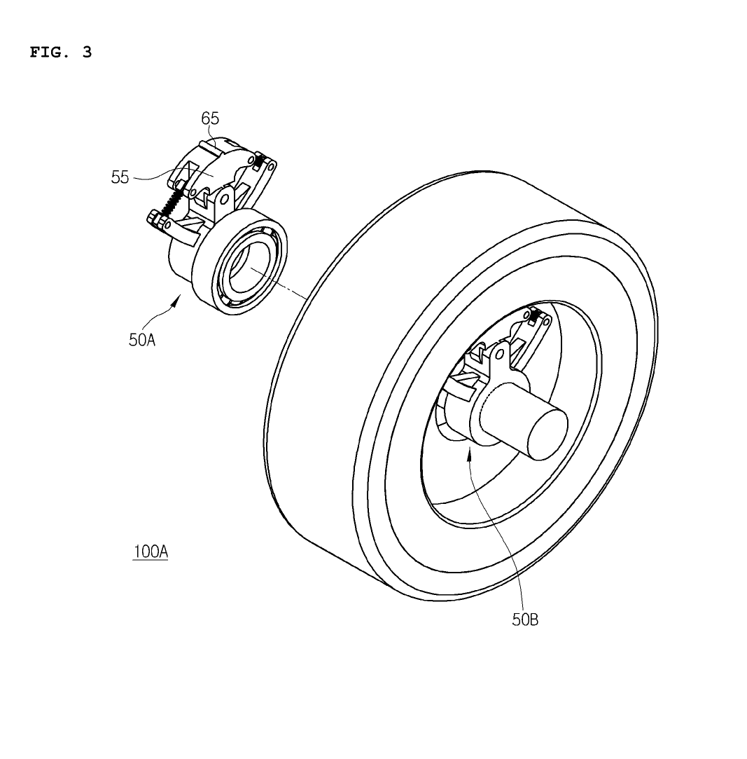

FIG. 1 is a perspective view of the right side of a caster 100 having a function of preventing a free rolling according to the present invention, FIG. 2 is an exploded perspective view of the left side of the caster 100 of FIG. 1, and FIG. 3 is an exploded perspective view of the right side of the caster 100 of FIG. 1.

As shown in FIGS. 1 to 3, the caster 100 includes: a wheel part 110 having a wheel 20 rotatably joined on a wheel shaft 30 and a bearing interposed between the wheel shaft 30 and the wheel 20; and a braking part 50 having a brake shoe 55 rotatably joined on the wheel shaft 30.

The wheel part 110 has a structure that the braking 40 is joined on the wheel shaft 30 and the wheel 20 is joined on the wheel shaft 30 at the position of the bearing 40 in such a way as to be rotated on the wheel shaft 30.

The wheel 20 is in a cylindrical shape and has both sides which are depressed inwardly and respectively have wheel inner walls 23. The wheel inner walls 23 may be formed in such a fashion that both sides of the wheel 20 outwardly protrude in a cylindrical form. The wheel inner walls 23 serve the same function as a brake disc face providing a braking force to prevent rotation of the caster when non-powered carriage equipment stops.

The braking part 50 includes: support rings 51 joined to the wheel shaft 30 at both sides of the bearing 40; the brake shoe 55 having one end hinge-coupled to the support ring 51 and the other end rotatably located toward the wheel inner wall 23; and elastic bodies 59 providing an elastic force so that the brake shoe 55 is located on the wheel shaft 30 in a vertical direction.

The support ring 51 has a hinge support portion 52 which protrudes from the outer peripheral surface of the support ring 51 at right angles to an axial direction of the wheel shaft 30 and to which an end portion of the brake shoe 55 is hinge-coupled by a hinge shaft 57. The hinge support portion 52 has a pair of elastic body supporting portions 53 protrudingly formed on both sides thereof.

The brake shoe 55 includes a brake protrusion 56 which gets in contact with the wheel inner wall 23 when the brake shoe 55 is located vertically to the wheel shaft 30 at the center of the surface abutting on the wheel inner wall 23. In this instance, the brake protrusion 56 is made of a friction material so as to provide a braking force to the rotation of the wheel 20 in a stopped state, and the brake shoe 55 excepting the brake protrusion 56 makes the rotation easy by the hinge shaft 57, and may be partially made of a low friction material, such as PP, so as to minimize a friction force when the brake shoe 55 gets in contact with the wheel inner wall.

As shown in FIGS. 1 to 3, the brake shoe 55 has a structure that one end portion of the brake shoe 55 is hinge-coupled to the hinge support portion 52 and the elastic bodies 59 have ends respectively joined to elastic body supporting portions 53 and the other ends respectively joined to both sides of the brake shoe 55, so that the brake shoe 55 is rotatable on the support ring 51 and is restored to the original position in a vertical direction. In the drawings, two elastic bodies 59 are connected to both sides of the brake shoe 55, but singular or plural elastic bodies 59 may be formed integrally with the brake shoe 55 in order to provide an elastically restoring force so that the brake shoe 55 can be always located on the wheel shaft 30 in the vertical direction. In other words, the elastic bodies 59 may have one of various shapes, such as compression springs, tension springs, distortion springs, wire forming springs, plate springs, and so on to provide the elastic force, so that the brake shoe 55 is vertically located on the wheel shaft 30.

In the caster 100 having the above structure, the bearing 40 is inserted into the wheel shaft 30, and then, the wheel 20 is axially joined to the bearing 40. After that, the brake shoe 55 and the elastic bodies 59 are joined on the wheel shaft 30 and the support ring 51 is joined to the wheel shaft 30, so that the braking part 50 is joined to the caster 100 in such a way as to be located at an area between the wheel shaft 30 and the wheel inner wall 23.

In this instance, the support ring 51 is forcedly fit to the wheel shaft 30 or is fixed to the wheel shaft 30 not to be rotated by fixing means, such as pins.

As described above, the braking part 50 joined to the caster 100 is joined to the wheel shaft 30 on one side of the caster 100 as shown in FIG. 1. Differently form the above, as shown in FIGS. 2 and 3, another caster 100A having a first braking part 50a and a second braking part 50B joined on both sides of the wheel 20 may be manufactured.

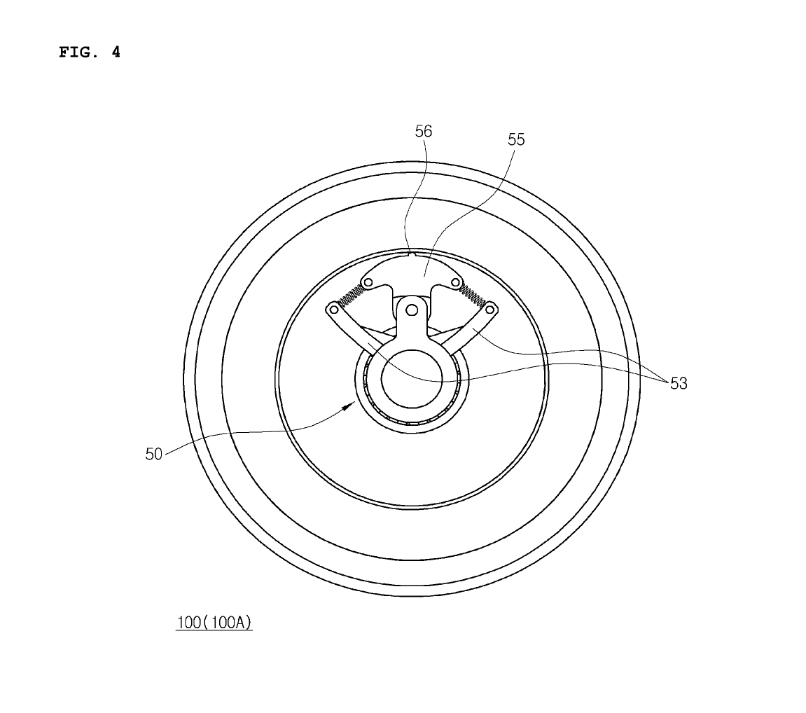

Hereinafter, referring to FIGS. 4 to 6, the function to provide the braking force to prevent rotation of the caster 100 in the stopped state and the function to remove the braking force in the rotation state will be described.

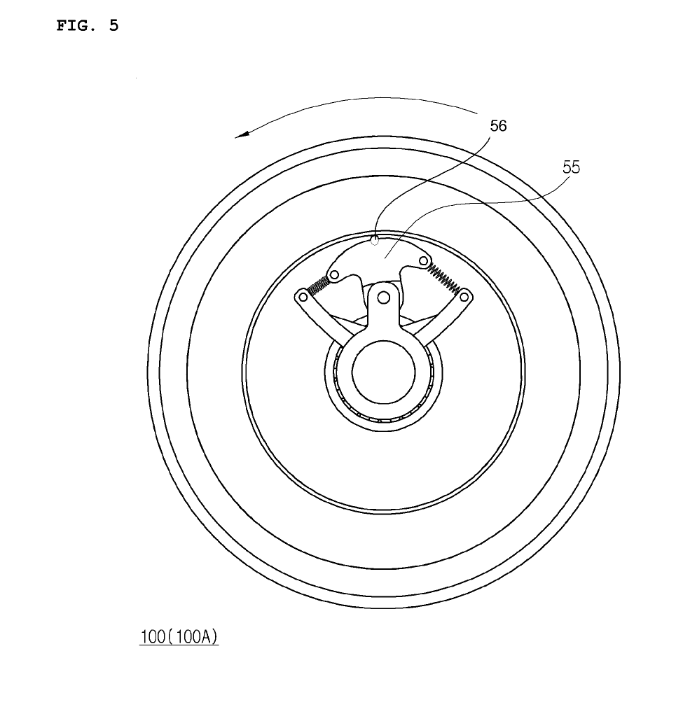

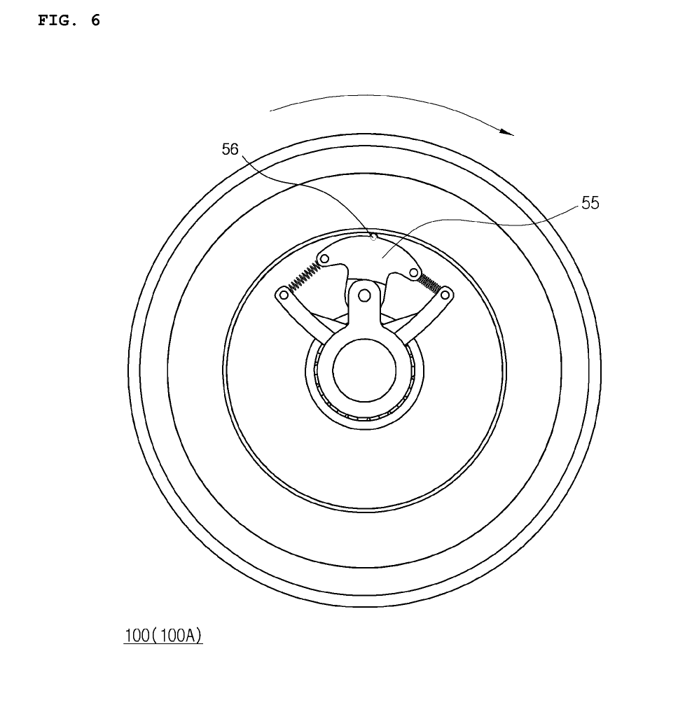

FIG. 4 is a view showing a braking action of a brake shoe in a stopped state of the caster of FIG. 1, FIG. 5 is a view showing a brake releasing action when the caster of FIG. 1 rotates in the counterclockwise direction, and FIG. 6 is a view showing a brake releasing action when the caster of FIG. 1 rotates in the clockwise direction.

When the non-powered carriage equipment (not shown) to which the caster 100 according to the present invention is applied is in the stopped state, as shown in FIG. 4, the elastic bodies 59 located at both sides of the brake shoe 55 provides the elastic force to pull bidirectionally, so that the brake shoe 55 is located at right angles to the wheel shaft 30. Therefore, the brake protrusion 56 gets in contact with the wheel inner wall 23 to carry out the braking function. Accordingly, the smart caster 100 according to the present invention can prevent an undesirable movement of the non-powered carriage equipment.

Differently from the above, in the case that the user draws the non-powered carriage equipment, the caster 100 is rotated, and hence, as shown in FIGS. 5 and 6, the brake shoe 55 is rotated in the rotational direction of the caster 100 or 100A on the hinge shaft 57 by the friction force between the brake protrusion 56 and the wheel inner wall 23, and hence the contact between the brake protrusion 56 and the wheel inner wall 23 is released, so that the braking force is removed and the caster 100 is in a free rolling state.

As described above, the smart caster according to the present invention automatically provides the braking force when the non-powered carriage equipment stops, but automatically removes the braking force of the caster 100 when the non-powered carriage equipment moves. Therefore, the smart caster according to the present invention increases convenience in use of the non-powered carriage equipment and remarkably enhances stability.

1. A smart caster having a function of preventing free rolling, the smart caster comprising:
a wheel part having a wheel rotatably joined to a wheel shaft and a bearing interposed between the wheel and the wheel shaft; and
a braking part rotatably joined to the wheel shaft, the braking part getting in contact with a wheel inner wall in a stopped state to provide braking force to the wheel and releasing a contact state between the braking part and the wheel inner wall in a rolling state of the wheel to remove the braking force of the wheel.

2. The smart caster according to claim 1, wherein the braking part comprises:
a brake shoe having an end portion hinge-coupled to the wheel shaft and rotatably located between the wheel inner wall and the wheel shaft in such a fashion that the brake shoe gets in contact with a wheel inner wall in the stopped state to provide braking force to the wheel and releases a contact state between the braking part and the wheel inner wall in the rolling state of the wheel to remove the braking force of the wheel; and
elastic bodies joined to the wheel shaft and the brake shoe, so that the brake shoe is located at right angles to an axial direction of the wheel shaft in the stopped state of the wheel.

3. The smart caster according to claim 2, wherein the brake shoe further comprises a brake protrusion protruding on the face getting in contact with the wheel inner wall in a direction of the wheel inner wall and getting in contact with the wheel inner wall so that the brake shoe easily gets in contact with the wheel and the contact state between the wheel and the brake shoe is easily removed.

4. The smart caster according to claim 3, wherein the brake protrusion comprises a friction member in order to increase the friction force with the wheel inner wall.

5. The smart caster according to claim 3, wherein the braking part further comprises:
a support ring joined on the shaft of the wheel shaft and hinge-coupled to an end portion of the brake shoe opposed to the wheel shaft, the support ring being joined with the elastic bodies, which elastically support both sides of the brake shoe and the hinge-coupled sides of the support ring.

6. The smart caster according to claim 5, wherein the support ring comprises:
elastic body supporting portions protruding on both sides where the brake shoe is hinge-coupled.

7. The smart caster according to claim 1, wherein a pair of the braking parts are joined to both sides of the wheel shaft of the wheel.
